(19) United States
(12) Patent Application Publication
(10) Pub. No.: US 2015/0149594 A1
(43) Pub. Date: May 28, 2015

(54) AUTOMATIC NODE DEPLOYMENT METHOD AND SERVER SYSTEM

(71) Applicants: INVENTEC CORPORATION, Taipei City (TW); INVENTEC (PUDONG) TECHNOLOGY CORPORATION, Shanghai (CN)

(72) Inventor: YING-CHIH LU, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 14/227,801

(22) Filed: Mar. 27, 2014

(30) Foreign Application Priority Data
Nov. 22, 2013 (CN) 201310596424.4

(51) Int. Cl. H04L 29/08

(52) U.S. Cl. CPC H04L 67/10
USPC 709/219

(57) ABSTRACT

Disclosed herein are a server system and an automatic node deployment method applicable thereto. The server system comprises first nodes, second nodes, a database, and a deployment module for receiving and obtaining the node information of the first nodes, for installing an operating system on each first node based on the said node information to identify the hardware information of the first nodes, for generating the second nodes based on the said hardware information, for receiving the node information of the second nodes to obtain the classification of the same, for installing a software package on each second node based on the said classification to deploy the second nodes to the server system for the server system to start up and operate normally, and for adjusting the number of the second nodes deployed in the server system based on a deployment strategy.

### CROSS-REFERENCE TO RELATED APPLICATIONS

This non-provisional application claims priority under 35 U.S.C. §119(a) on Patent Application No. 201310596424.4 filed in People's Republic of China on Nov. 22, 2013, the entire contents of which are hereby incorporated by reference.

### TECHNICAL FIELD

The present invention relates to server technology, particularly to the automatic deployment of nodes based on the load of a server system.

### BACKGROUND

The three major models of cloud computing are software as a service (SaaS), platform as a service (PaaS), and infrastructure as a service (IaaS). IaaS has been applied to many aspects of networking, giving rise to virtual storage, virtual machines, virtual machine clusters, and virtual data centers, based on which network services are provided, e.g. monitor servers or servers of Preboot Execution Environment (PXE), Dynamic Host Configuration Protocol (DHCP), Network Time Protocol (NTP), or the Domain Name System (DNS). The load on such a server depends on how many users are accessing it at a given instant. A spike in the number of users often overwhelms the server to the point of crash or irresponsiveness, while the resources of the server lie wasted when there are not enough users. Network services have gradually migrated to the more flexible IaaS precisely because users come and go all the time.

Nevertheless, resources in a contemporary IaaS model are pre-allocated according to the type of service provided. The allocation may be, for example, storage- or computation-oriented. The instantaneous load of a network service must therefore be monitored and its resources manually adjusted by an administrator, who poses an extra investment in human capital and often fails to respond to fluctuations of the number of users in time. Although for certain times of the day the adjustment can be made periodically and preemptively, the load is usually so unpredictable that the periodicity itself is a burden on the infrastructure.

### SUMMARY

In light of the above, the present invention discloses a server system and a method of automatic node deployment according to the load of the server system. Specifically, nodes are added in timely response to an increased load that could slow down or paralyze the server system, or released for use by other services as soon as the load is lightened. The server system stabilizes when its resource demand is promptly and productively met.

The automatic node deployment method provided by this disclosure is applicable to a server system having a plurality of first nodes, whose node information is first received and obtained. On each of the first nodes an operating system is installed based on the said node information, in order for the hardware information of the first nodes to be identified. The said hardware information is integrated to generate a plurality of second nodes, whose node information is then received for their classification to be obtained. A software package is installed on each of the second nodes based on the said classification so that the server system starts up and operates normally when the second nodes are deployed thereto. Finally, the number of the second nodes deployed in the server system is adjusted based on a deployment strategy.

The server system provided by this disclosure comprises first nodes, second nodes, a database, and a deployment module. The second nodes are generated by integrating the hardware information of the first nodes. The database is adapted for storing the node information of the first nodes, the node information of the second nodes, and the classification of the second nodes. The deployment module, coupled to the first nodes, the second nodes, and the database, is adapted for receiving and obtaining the node information of the first nodes, for installing an operating system on each first node based on the said node information to identify the hardware information of the first nodes, for generating the second nodes based on the said hardware information, for receiving the node information of the second nodes to obtain the classification of the same, for installing a software package on each second node based on the said classification to deploy the second nodes to the server system for the server system to start up and operate normally, and for adjusting the number of the second nodes deployed in the server system based on a deployment strategy.

### BRIEF DESCRIPTION OF THE DRAWING

The present invention will become more fully understood from the detailed description given hereinbelow and the accompanying drawings which are given by way of illustration only and thus are not limitative of the present invention and wherein:

FIG. 1 is a high-level block diagram of a server system, in accordance with an embodiment of the present invention.

FIG. 2 is a flowchart of an automatic node deployment method, in accordance with an embodiment of the present invention.

FIG. 3 illustrates adjusting the number of nodes deployed in a server system based on a deployment strategy, in accordance with an embodiment of the present invention.

FIG. 4 is a high-level block diagram of a server system, in accordance with another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

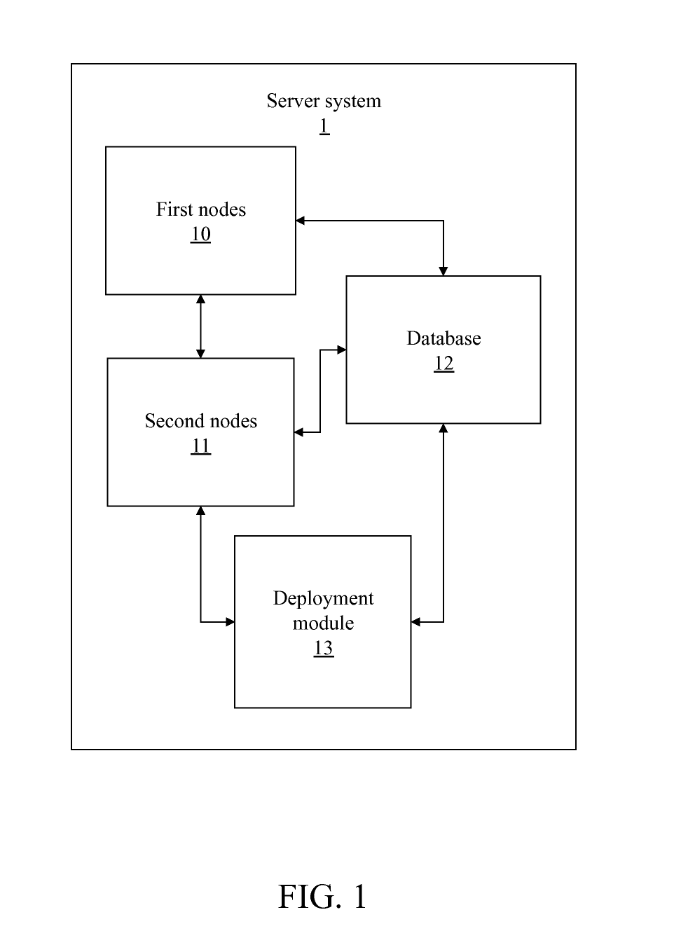

Please refer to FIG. 1. As shown in the block diagram, a server system 1 comprises first nodes 10, second nodes 11, a database 12, and a deployment module 13. The server system 1, a cloud service provision server for example, is configured to provide a SaaS-, PaaS-, or IaaS-modeled cloud service and allocate relevant resources. The first nodes 10 may be basic resource nodes generated when the server system 1 allocates hardware resources. A basic resource node, having just the information on its hardware configuration, is not operable without an operating system. A second node 11 may be a service node, a storage node, or a computation node assembled from the first nodes 10. Before the assembly, a first node 10 has to be installed with an operating system for its hardware information to be identified.

In this embodiment, an aforementioned service node is configured to provide Internet services, such as Hypertext Transfer Protocol (HTTP) or database access; an aforementioned storage node is configured to provide cloud data access services, such as File Transfer Protocol (FTP) or cloud drives; an aforementioned computation node is configured to provide cloud computing services, such as mass data organization or customer relationship management (CRM). The database 12 stores the node information of the first nodes 10, and the node information and classification of the second nodes 11. The deployment module 13 deploys the second nodes 11 according to the database 12, and increases or decreases the number of the second nodes 11 deployed based on a deployment strategy. The deployment module 13 may further create a classification list recording the classification of the second nodes 11 to speed up the deployment.

In one embodiment, the processing unit of the server system 1 performs initialization after the server system 1 is started up. The initialization of the server system 1 done, the processing unit detects the number and information of the first nodes 10. The information may include the MAC (media access control) or IP (Internet Protocol) address of the baseboard management controller (BMC) and that of the host. The detection may be the processing unit running at set times an automatic node detection daemon providing an application programming interface (API) for interaction with other threads through, say, IPC (inter-process communication) sockets. The number and information of the first nodes 10 detected thus are stored into the database 12 by the server system 1. The processing unit may further execute at set times a node provision daemon with which the server system 1 installs operating systems onto the first nodes 10 to identify their hardware information, e.g. SMBIOS (System Management BIOS) data. The operating systems may be installed using PXE.

Subsequently, the second nodes 11 are generated by the processing unit integrating the first nodes 10 and may be classified into service nodes, storage nodes, and computation nodes. For instance, a service node, a storage node, and a computation node among the second nodes 11 may consist of one, three, and two first nodes 10, respectively. The constitution and number of these nodes is of course subject to adjustment by the server system 1 according to its needs.

The node provision daemon stores the node information and classification of the second nodes 11 in the database 12. Based on the stored data, a corresponding software package is installed on each second node 11. The deployment module 13 deploys the second nodes 11 into the server system 1, causing it to start up and operate normally, and adjusts the number of the second nodes 11 deployed based on a deployment strategy that is adapted to the load of the server system 1. The server system 1 may deploy the least number of second nodes 11 required through a minimum cloud deployment daemon, and execute an on-demand cloud deployment daemon to adjust the number of the second nodes 11 as dictated by the load.

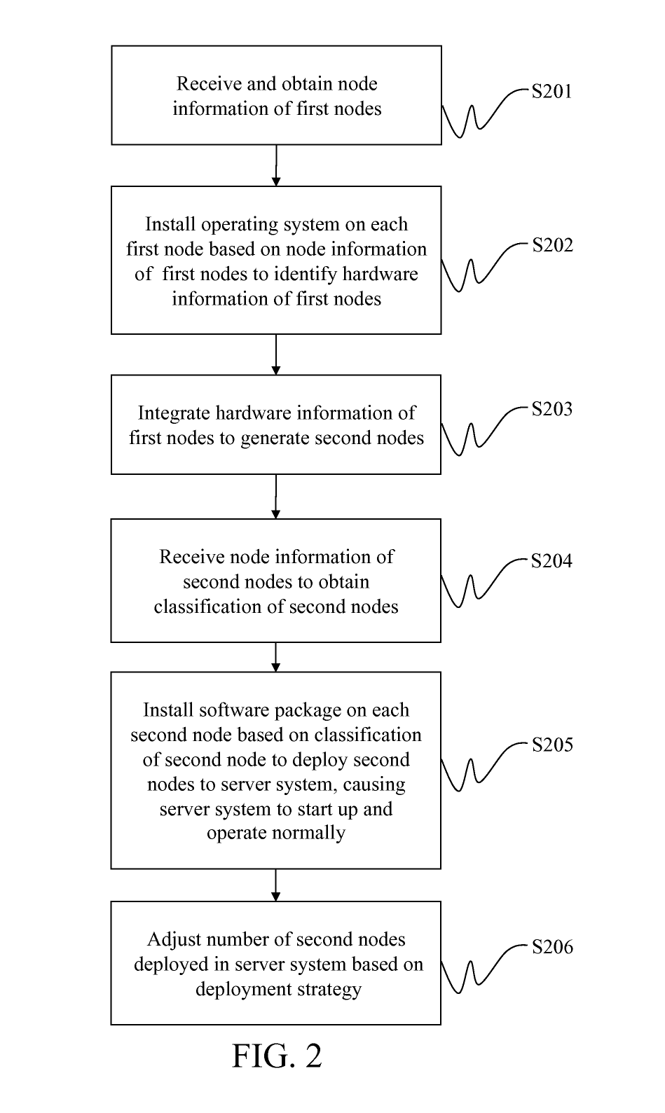

An automatic node deployment method applicable to a server system can be concluded from the above, as illustrated in FIG. 2. In step S201, the node information of first nodes is received and obtained. The information may include the MAC or IP address of the BMC and that of the host. In step S202, an operating system is installed on each of the first nodes based on the said node information, in order for the hardware information of the first nodes to be identified. The hardware information, which may be recorded per SMBIOS, is integrated in step S203 to generate second nodes. In step S204, the node information of the second nodes is received for their classification to be obtained. In step S205, a software package is installed on each of the second nodes based on the said classification in order to deploy the second nodes to the server system, causing it to starts up and operates normally. In step S206, the number of the second nodes deployed in the server system is adjusted based on a deployment strategy.

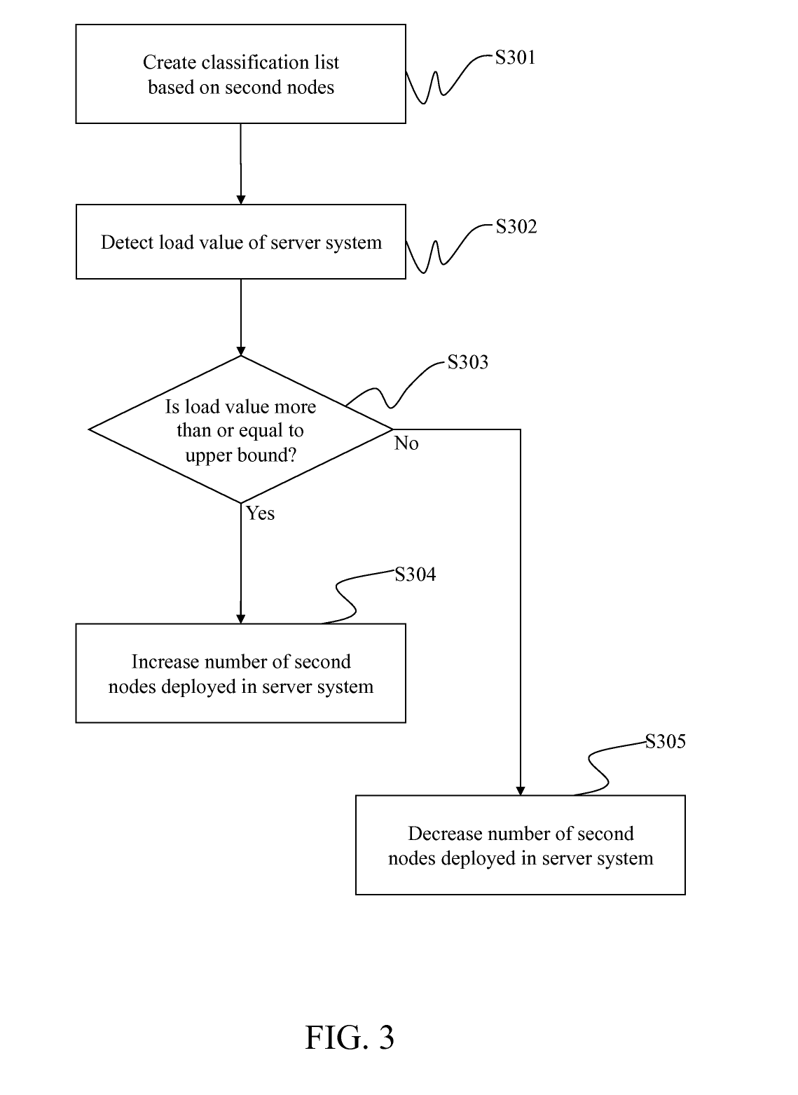

Please refer to FIG. 3 for an elaboration of step S206. As shown in the flowchart, in step S301 a classification list is created based on the second nodes. In step S302, a load value of the server system is detected. The number of the second nodes deployed in the server system is increased in step S304 if it is determined in step S303 that the load value is more than or equal to an upper bound, or otherwise decreased in step S305.

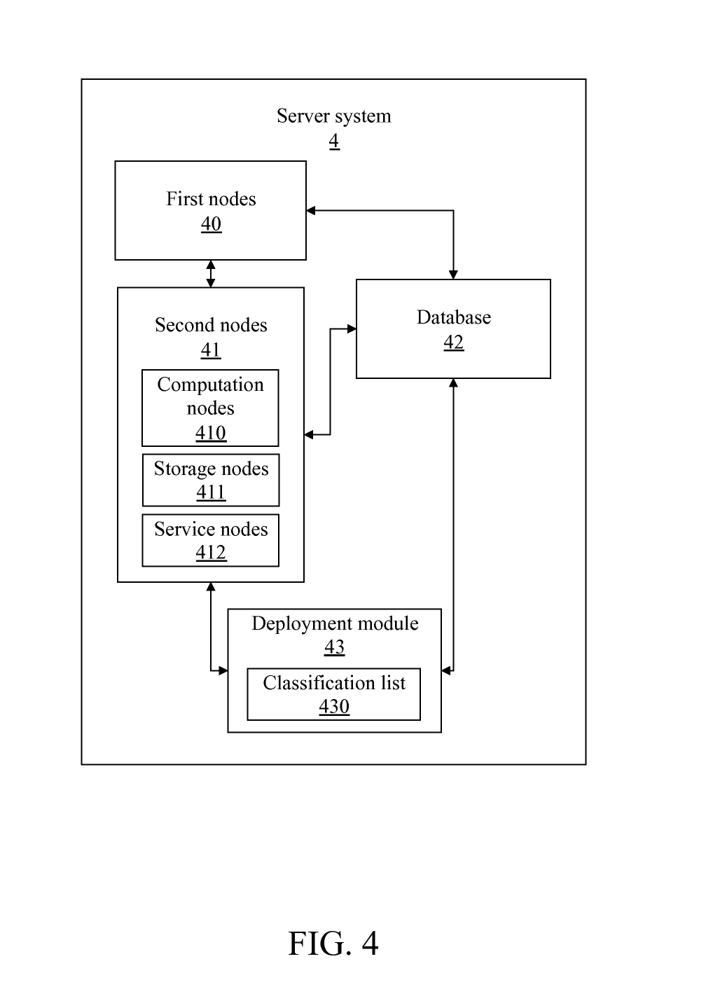

Please refer to FIG. 4, which compares with FIG. 1. When the server system 4 finishes starting up, the first nodes 40 have been detected and installed with operating systems by the processing unit, their information integrated to generate computation nodes 410, storage nodes 411, and service nodes 412 among the second nodes 41. The deployment module 43 has also generated a classification list 430 for recording the classification of the second nodes 41, such as into the nodes 410 to 412.

Consider the server system 4 as a web server. The number and habits of the browsing clients fluctuate and differ from one time of the day to another. An upper bound of the service load may be predefined as 80% and a lower bound may be 20%. The server system 4 may run a daemon periodically monitoring the ebb and flow of its service load. Through the classification list 430, the deployment module 43 increases the number of the service nodes 412 in the server system 4 when it is predicted that the service load is about to exceed 80%, and decreases it when the forecast is below 20%. In short, the server system 4 adapts its capacity for network connections by altering the number of the service nodes 412. Bursts of webpage requests can be accommodated, and resources released for use by other services when there are not many connections.

Consider the server system 4 as a file server constantly receiving uploaded files. There is limited storage space in the server system 4; more storage nodes 411 are required to enlarge the space. An upper bound of the storage load may be predefined as 90% and a lower bound may be 10%. The server system 4 may run a daemon periodically monitoring the ebb and flow of its storage load. Through the classification list 430, the deployment module 43 increases the number of the storage nodes 411 in the server system 4 when it is predicted that the storage load is about to exceed 90%, and decreases it when the forecast is below 10%. In short, the server system 4 adapts its available space by altering the number of the storage nodes 411. Storage space can be found when there is not enough, and relinquished when freed up or left unused.

Consider the server system 4 as a media transcoding server constantly converting large amounts of videos from one format to another. There is limited computing power in the central processing unit (CPU) of the server system 4; more computation nodes 410 are required to boost the performance. An upper bound of the computation load may be predefined as 70% and a lower bound may be 30%. The server system 4 may run a daemon periodically monitoring the ebb and flow of its computation load. Through the classification list 430, the deployment module 43 increases the number of the computation nodes 410 in the server system 4 when it is predicted that the computation load is about to exceed 70%, and decreases it when the forecast is below 30%. In short, the server system 4 adapts its available computing power by altering the number of the computation nodes 410. Computing power can be sourced when a performance bottleneck is reached, and relinquished when freed up or left unused.

What is claimed is:

1. An automatic node deployment method applicable to a server system having a plurality of first nodes, the automatic node deployment method comprising:
receiving and obtaining the node information of the first nodes;
installing an operating system on each of the first nodes based on the node information of the first nodes, in order to identify the hardware information of the first nodes;
integrating the hardware information of the first nodes to generate a plurality of second nodes;
receiving the node information of the second nodes to obtain the classification of the second nodes;
installing a software package on each of the second nodes based on the classification of the second nodes, in order to deploy the second nodes to the server system, causing the server system to start up and operate normally; and
adjusting the number of the second nodes deployed in the server system based on a deployment strategy.

2. The automatic node deployment method of claim 1, wherein the number of the second nodes deployed in the server system is as small as the server system is operable.

3. The automatic node deployment method of claim 1, wherein adjusting the number of the second nodes deployed in the server system comprises:
creating a classification list based on the second nodes;
detecting a load value of the server system; and
increasing the number of the second nodes deployed in the server system when the load value is not less than an upper bound.

4. The automatic node deployment method of claim 3, wherein detecting the load value comprises decreasing the number of the second nodes deployed in the server system when the load value is less than a lower bound.

5. A server system comprising:
a plurality of first nodes;
a plurality of second nodes generated by integrating the hardware information of the first nodes;
a database for storing the node information of the first nodes, the node information of the second nodes, and the classification of the second nodes; and
a deployment module coupled to the first nodes, the second nodes, and the database, for receiving and obtaining the node information of the first nodes, for installing an operating system on each of the first nodes based on the node information of the first nodes to identify the hardware information of the first nodes, for generating the second nodes based on the hardware information of the first nodes, for receiving the node information of the second nodes to obtain the classification of the second nodes, for installing a software package on each of the second nodes based on the classification of the second nodes to deploy the second nodes to the server system for the server system to start up and operate normally, and for adjusting the number of the second nodes deployed in the server system based on a deployment strategy.

6. The server system of claim 5, wherein the number of the second nodes deployed in the server system is as small as the server system is operable.

7. The server system of claim 5, wherein the deployment strategy comprises creating a classification list based on the second nodes, detecting a load value of the server system, and increasing the number of the second nodes deployed in the server system when the load value is not less than an upper bound.

8. The server system of claim 7, wherein the number of the second nodes deployed in the server system is decreased when the load value is less than the upper bound.
